(19) United States
(12) Patent Application Publication
(10) Pub. No.: US 2025/0375989 A1
(43) Pub. Date: Dec. 11, 2025

(54) HITCH ANGLE CALCULATION DEVICE, HITCH ANGLE CALCULATION METHOD, AND NON-TRANSITORY RECORDING MEDIUM

(71) Applicants: TOYOTA JIDOSHA KABUSHIKI KAISHA, Toyota-shi Aichi-ken (JP); DENSO CORPORATION, Kariya-city Aichi-pref (JP)

(72) Inventor: Masahiro Kawabata, Koto-ku Tokyo-to (JP)

(73) Assignees: TOYOTA JIDOSHA KABUSHIKI KAISHA, Toyota-shi Aichi-ken (JP); DENSO CORPORATION, Kariya-city Aichi-pref (JP)

(21) Appl. No.: 19/224,002

(22) Filed: May 30, 2025

(30) Foreign Application Priority Data
Jun. 5, 2024 (JP) 2024-091686

(51) Int. Cl. B60D 1/36; B60D 1/30

(52) U.S. Cl. CPC B60D 1/36; B60D 1/305

(57) ABSTRACT

A hitch angle calculation device calculates coordinates of left and right lower ends of a trailer and hitch ball included in an image shot by a vehicle-mounted camera after calibration travel of a vehicle towing the trailer via a tow bar, transforms them to coordinates in a world coordinate system, calculates distance between the left lower end and the hitch ball and distance between the right lower end and the hitch ball, corrects the coordinate of the left lower end so that the distance between the left lower end and the hitch ball is equal to an average value, corrects the coordinate of the right lower end so that the distance between the right lower end and the hitch ball is equal to the average value, and calculates a hitch angle of the trailer based on the corrected coordinates of the left and the right lower ends.

### CROSS-REFERENCE TO RELATED APPLICATIONS

This application claims priority to Japanese Patent Application No. 2024-091686 filed Jun. 5, 2024, the entire contents of which are herein incorporated by reference.

### FIELD

The present disclosure relates to hitch angle calculation device, hitch angle calculation method, and non-transitory recording medium.

### BACKGROUND

PTL 1 (JP 2023-536469 A) describes a technique for determining a trailer angle between a tow vehicle and a trailer attached to the tow vehicle. In the technique described in PTL 1, visual features are determined from an image captured by a camera arranged at the rear of the tow vehicle, the visual features are tracked while the tow vehicle and trailer are moving, and the trailer angle is calculated based on the visual features in data process hardware. PTL 1 also describes coordinate system transformation from world coordinates to camera coordinates. PTL 1 further describes that deviating outliers are filtered out.

However, when the coordinate system transformation of an image is performed, visual features including errors that have not been removed by filtering may be present among the visual features after the coordinate system transformation. When visual features including errors are present, if the trailer angle (hitch angle) is calculated based on the visual features including errors without correcting the visual features including errors, in the manner of the technique described in PTL 1, for example, an inaccurate trailer angle (hitch angle) may be calculated. Specifically, in the technique described in PTL 1, in which the visual features are not corrected, the trailer angle (hitch angle) may be calculated inappropriately.

### SUMMARY

In view of the above-described points, it is an object of the present disclosure to provide hitch angle calculation device, hitch angle calculation method, and a non-transitory recording medium with which hitch angle can be appropriately calculated.

(1) One aspect of the present disclosure is a hitch angle calculation device including a processor configured to: acquire images shot by a camera mounted on a vehicle towing a trailer via a tow bar at a plurality of time points during a calibration travel of the vehicle; calculate coordinates of left lower end of the trailer, right lower end of the trailer, and hitch ball on the images, the left lower end of the trailer, the right lower end of the trailer, and the hitch ball being included in each of the images; transform the coordinates of the left lower end on the images to the coordinates of the left lower end in a world coordinate system, transform the coordinates of the right lower end on the images to the coordinates of the right lower end in the world coordinate system, and transform the coordinates of the hitch ball on the images to the coordinates of the hitch ball in the world coordinate system; calculate a first average value which is an average value of a distance between the left lower end and the hitch ball in the world coordinate system during the calibration travel of the vehicle based on the coordinates of the left lower end and the hitch ball in the world coordinate system at time points during the calibration travel of the vehicle, and calculate a second average value which is the average value of the distance between the right lower end and the hitch ball in the world coordinate system during the calibration travel of the vehicle based on the coordinates of the right lower end and the hitch ball in the world coordinate system at time points during the calibration travel of the vehicle; remove the coordinates of the left lower end in the world coordinate system satisfying a first coordinate removal condition when the coordinates of the left lower end in the world coordinate system satisfying the first coordinate removal condition are included in the coordinates of the left lower end in the world coordinate system at time points during the calibration travel of the vehicle, remove the coordinates of the right lower end in the world coordinate system satisfying a second coordinate removal condition when the coordinates of the right lower end in the world coordinate system satisfying the second coordinate removal condition are included in the coordinates of the right lower end in the world coordinate system at time points during the calibration travel of the vehicle, and remove the coordinates of the hitch ball in the world coordinate system satisfying a third coordinate removal condition when the coordinates of the hitch ball in the world coordinate system satisfying the third coordinate removal condition are included in the coordinates of the hitch ball in the world coordinate system at time points during the calibration travel of the vehicle; calculate third average value or fourth average value and average value of the coordinates of the hitch ball in the world coordinate system by using the coordinates of the left lower end, the right lower end, and the hitch ball in the world coordinate system at the plurality of time points during the calibration travel of the vehicle which are not removed, the third average value being an average value of a distance between the left lower end and the hitch ball in the world coordinate system, the fourth average value being an average value of a distance between the right lower end and the hitch ball in the world coordinate system; and calculate a hitch angle of the trailer at a predetermined time point based on a hitch angle calculation target image, which is an image shot by the camera at the predetermined time point after the calibration travel of the vehicle, wherein the processor is configured to: calculate coordinates of the left lower end, the right lower end, and the hitch ball on the image included in the hitch angle calculation target image; transform the coordinates of the left lower end, the right lower end, and the hitch ball on the image included in the hitch angle calculation target image to coordinates in the world coordinate system; calculate distance in the world coordinate system between the left lower end and the hitch ball included in the hitch angle calculation image and distance in the world coordinate system between the right lower end and the hitch ball included in the hitch angle calculation target image based on the coordinates in the world coordinate system of the left lower end, the right lower end, and the hitch ball included in the hitch angle calculation target image; correct the coordinate in the world coordinate system of the left lower end included in the hitch angle calculation target image so that the distance in the world coordinate system between the left lower end and the hitch ball included in the hitch angle calculation target image is equal to the third average value or the fourth average value; correct the coordinate in the world coordinate system of the right lower end included in the hitch angle calculation target image so that the distance in the world coordinate system between the right lower end and the hitch ball included in the hitch angle calculation target image is equal to the third average value or the fourth average value; and calculate the hitch angle of the trailer at the predetermined time point based on the corrected coordinate in the world coordinate system of the left lower end included in the hitch angle calculation target image and the corrected coordinate in the world coordinate system of the right lower end included in the hitch angle calculation target image.

(2) In the hitch angle calculation device of the aspect (1), the processor may be configured to: correct the coordinate in the world coordinate system of the left lower end included in the hitch angle calculation target image so that the distance in the world coordinate system between the left lower end and the hitch ball included in the hitch angle calculation target image is equal to the third average value or the fourth average value and so that an orientation of the left lower end with respect to the hitch ball in the world coordinate system does not change; and correct the coordinate in the world coordinate system of the right lower end included in the hitch angle calculation target image so that the distance in the world coordinate system between the right lower end and the hitch ball included in the hitch angle calculation target image is equal to the third average value or the fourth average value and so that an orientation of the right lower end with respect to the hitch ball in the world coordinate system does not change.

(3) In the hitch angle calculation device of the aspect (1) or (2), the processor may be configured to: determine that the first coordinate removal condition is satisfied when the coordinates of the left lower end in the world coordinate system during the calibration travel of the vehicle are located outside of a predetermined first area, and remove the coordinates of the left lower end in the world coordinate system at time points when the coordinates of the left lower end in the world coordinate system are located outside of the first area; determine that the second coordinate removal condition is satisfied when the coordinates of the right lower end in the world coordinate system during the calibration travel of the vehicle are located outside of the first area, and remove the coordinates of the right lower end in the world coordinate system at time points when the coordinates of the right lower end in the world coordinate system are located outside of the first area; and determine that the third coordinate removal condition is satisfied when the coordinates of the hitch ball in the world coordinate system during the calibration travel of the vehicle are located outside of a predetermined second area, and remove the coordinates of the hitch ball in the world coordinate system at time points when the coordinates of the hitch ball in the world coordinate system are located outside of the second area.

(4) Another aspect of the present disclosure is a hitch angle calculation method including: acquiring images shot by a camera mounted on a vehicle towing a trailer via a tow bar at a plurality of time points during a calibration travel of the vehicle; calculating coordinates of left lower end of the trailer, right lower end of the trailer, and hitch ball on the images, the left lower end of the trailer, the right lower end of the trailer, and the hitch ball being included in each of the images; transforming the coordinates of the left lower end on the images to the coordinates of the left lower end in a world coordinate system, transforming the coordinates of the right lower end on the images to the coordinates of the right lower end in the world coordinate system, and transforming the coordinates of the hitch ball on the images to the coordinates of the hitch ball in the world coordinate system; calculating a first average value which is an average value of a distance between the left lower end and the hitch ball in the world coordinate system during the calibration travel of the vehicle based on the coordinates of the left lower end and the hitch ball in the world coordinate system at time points during the calibration travel of the vehicle, and calculating a second average value which is the average value of the distance between the right lower end and the hitch ball in the world coordinate system during the calibration travel of the vehicle based on the coordinates of the right lower end and the hitch ball in the world coordinate system at time points during the calibration travel of the vehicle; removing the coordinates of the left lower end in the world coordinate system satisfying a first coordinate removal condition when the coordinates of the left lower end in the world coordinate system satisfying the first coordinate removal condition are included in the coordinates of the left lower end in the world coordinate system at time points during the calibration travel of the vehicle, removing the coordinates of the right lower end in the world coordinate system satisfying a second coordinate removal condition when the coordinates of the right lower end in the world coordinate system satisfying the second coordinate removal condition are included in the coordinates of the right lower end in the world coordinate system at time points during the calibration travel of the vehicle, and removing the coordinates of the hitch ball in the world coordinate system satisfying a third coordinate removal condition when the coordinates of the hitch ball in the world coordinate system satisfying the third coordinate removal condition are included in the coordinates of the hitch ball in the world coordinate system at time points during the calibration travel of the vehicle; calculating third average value or fourth average value and average value of the coordinates of the hitch ball in the world coordinate system by using the coordinates of the left lower end, the right lower end, and the hitch ball in the world coordinate system at the plurality of time points during the calibration travel of the vehicle which are not removed, the third average value being an average value of a distance between the left lower end and the hitch ball in the world coordinate system, the fourth average value being an average value of a distance between the right lower end and the hitch ball in the world coordinate system; and calculating a hitch angle of the trailer at a predetermined time point based on a hitch angle calculation target image, which is an image shot by the camera at the predetermined time point after the calibration travel of the vehicle, wherein coordinates of the left lower end, the right lower end, and the hitch ball on the image included in the hitch angle calculation target image are calculated, the coordinates of the left lower end, the right lower end, and the hitch ball on the image included in the hitch angle calculation target image are transformed to coordinates in the world coordinate system, distance in the world coordinate system between the left lower end and the hitch ball included in the hitch angle calculation image and distance in the world coordinate system between the right lower end and the hitch ball included in the hitch angle calculation target image are calculated based on the coordinates in the world coordinate system of the left lower end, the right lower end, and the hitch ball included in the hitch angle calculation target image, the coordinate in the world coordinate system of the left lower end included in the hitch angle calculation target image is corrected so that the distance in the world coordinate system between the left lower end and the hitch ball included in the hitch angle calculation target image is equal to the third average value or the fourth average value, the coordinate in the world coordinate system of the right lower end included in the hitch angle calculation target image is corrected so that the distance in the world coordinate system between the right lower end and the hitch ball included in the hitch angle calculation target image is equal to the third average value or the fourth average value, and the hitch angle of the trailer at the predetermined time point is calculated based on the corrected coordinate in the world coordinate system of the left lower end included in the hitch angle calculation target image and the corrected coordinate in the world coordinate system of the right lower end included in the hitch angle calculation target image.

(5) Another aspect of the present disclosure is a non-transitory recording medium having recorded thereon a computer program for causing a processor to perform a process including: acquiring images shot by a camera mounted on a vehicle towing a trailer via a tow bar at a plurality of time points during a calibration travel of the vehicle; calculating coordinates of left lower end of the trailer, right lower end of the trailer, and hitch ball on the images, the left lower end of the trailer, the right lower end of the trailer, and the hitch ball being included in each of the images; transforming the coordinates of the left lower end on the images to the coordinates of the left lower end in a world coordinate system, transforming the coordinates of the right lower end on the images to the coordinates of the right lower end in the world coordinate system, and transforming the coordinates of the hitch ball on the images to the coordinates of the hitch ball in the world coordinate system; calculating a first average value which is an average value of a distance between the left lower end and the hitch ball in the world coordinate system during the calibration travel of the vehicle based on the coordinates of the left lower end and the hitch ball in the world coordinate system at time points during the calibration travel of the vehicle, and calculating a second average value which is the average value of the distance between the right lower end and the hitch ball in the world coordinate system during the calibration travel of the vehicle based on the coordinates of the right lower end and the hitch ball in the world coordinate system at time points during the calibration travel of the vehicle; removing the coordinates of the left lower end in the world coordinate system satisfying a first coordinate removal condition when the coordinates of the left lower end in the world coordinate system satisfying the first coordinate removal condition are included in the coordinates of the left lower end in the world coordinate system at time points during the calibration travel of the vehicle, removing the coordinates of the right lower end in the world coordinate system satisfying a second coordinate removal condition when the coordinates of the right lower end in the world coordinate system satisfying the second coordinate removal condition are included in the coordinates of the right lower end in the world coordinate system at time points during the calibration travel of the vehicle, and removing the coordinates of the hitch ball in the world coordinate system satisfying a third coordinate removal condition when the coordinates of the hitch ball in the world coordinate system satisfying the third coordinate removal condition are included in the coordinates of the hitch ball in the world coordinate system at time points during the calibration travel of the vehicle; calculating third average value or fourth average value and average value of the coordinates of the hitch ball in the world coordinate system by using the coordinates of the left lower end, the right lower end, and the hitch ball in the world coordinate system at the plurality of time points during the calibration travel of the vehicle which are not removed, the third average value being an average value of a distance between the left lower end and the hitch ball in the world coordinate system, the fourth average value being an average value of a distance between the right lower end and the hitch ball in the world coordinate system; and calculating a hitch angle of the trailer at a predetermined time point based on a hitch angle calculation target image, which is an image shot by the camera at the predetermined time point after the calibration travel of the vehicle, wherein coordinates of the left lower end, the right lower end, and the hitch ball on the image included in the hitch angle calculation target image are calculated, the coordinates of the left lower end, the right lower end, and the hitch ball on the image included in the hitch angle calculation target image are transformed to coordinates in the world coordinate system, distance in the world coordinate system between the left lower end and the hitch ball included in the hitch angle calculation image and distance in the world coordinate system between the right lower end and the hitch ball included in the hitch angle calculation target image are calculated based on the coordinates in the world coordinate system of the left lower end, the right lower end, and the hitch ball included in the hitch angle calculation target image, the coordinate in the world coordinate system of the left lower end included in the hitch angle calculation target image is corrected so that the distance in the world coordinate system between the left lower end and the hitch ball included in the hitch angle calculation target image is equal to the third average value or the fourth average value, the coordinate in the world coordinate system of the right lower end included in the hitch angle calculation target image is corrected so that the distance in the world coordinate system between the right lower end and the hitch ball included in the hitch angle calculation target image is equal to the third average value or the fourth average value, and the hitch angle of the trailer at the predetermined time point is calculated based on the corrected coordinate in the world coordinate system of the left lower end included in the hitch angle calculation target image and the corrected coordinate in the world coordinate system of the right lower end included in the hitch angle calculation target image.

According to the present disclosure, hitch angle can be appropriately calculated.

### BRIEF DESCRIPTION OF DRAWINGS

FIG. 1 is a view showing an example of a vehicle 1 to which a hitch angle calculation device 14 of a first embodiment is applied.

FIG. 2A is a view of the vehicle 1, trailer TR, and tow bar DB from above.

FIG. 2B is a view showing an example of an image IM including the trailer TR and the tow bar DB shot by a camera 11 mounted on the vehicle 1.

FIG. 2C is a view showing an example of a calibration travel of the vehicle 1.

FIG. 3A is a view showing an example of a transformation from coordinates on the image IM shown in FIG. 2B to coordinates in a world coordinate system.

FIG. 3B is a view showing an example of an average value (first average value) R1 of distance between left lower end TRL of the trailer TR and hitch ball HB in the world coordinate system during the calibration travel of the vehicle 1 calculated by a second calculation unit 3D.

FIG. 3C is a view showing an example of the average value (second average value) R2 of the distance between right lower end TRR of the trailer TR and the hitch ball HB in the world coordinate system during the calibration travel of the vehicle 1 calculated by the second calculation unit 3D.

FIG. 4A is a view showing an example of the relationship between first area AR1, coordinate (xL, yL) of the left lower end TRL in the world coordinate system at a time point during the calibration travel of the vehicle 1 and coordinate (xR, yR) of the right lower end TRR in the world coordinate system at that time point.

FIG. 4B is a view showing an example of the relationship between second area AR2 and coordinate (xH, yH) of the hitch ball HB in the world coordinate system at a time point during the calibration travel of the vehicle 1.

FIG. 5 is a view for explaining an example of correction of the coordinate (xL, yL) of the left lower end TRL in the world coordinate system included in the hitch angle calculation target image performed by a hitch angle calculation unit 3G.

FIG. 6 is a flowchart for explaining an example of a process executed by a processor 143 of the hitch angle calculation device 14 of the first embodiment.

### DESCRIPTION OF EMBODIMENTS

Below, referring to the drawings, embodiments of hitch angle calculation device, hitch angle calculation method, and non-transitory recording medium of the present disclosure will be described.

### First Embodiment

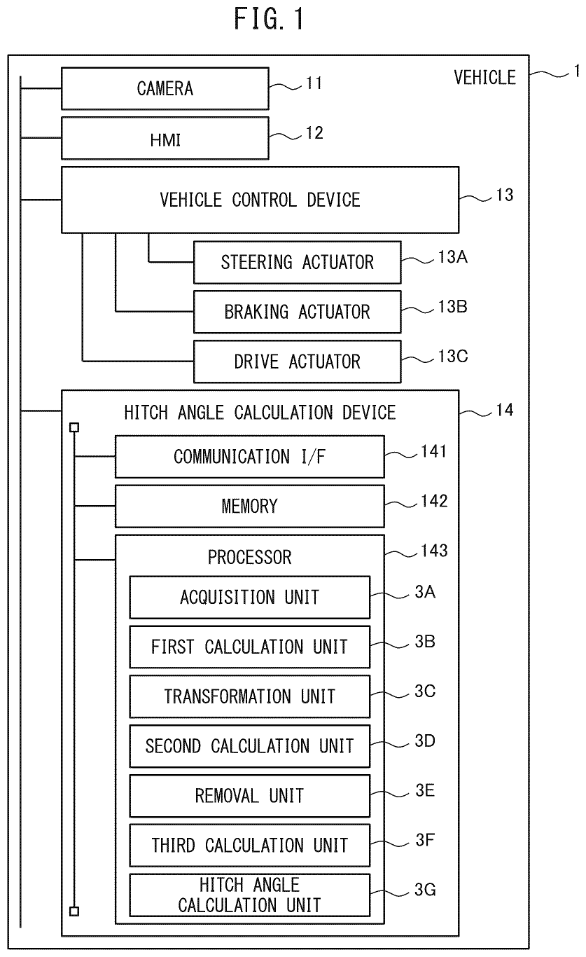

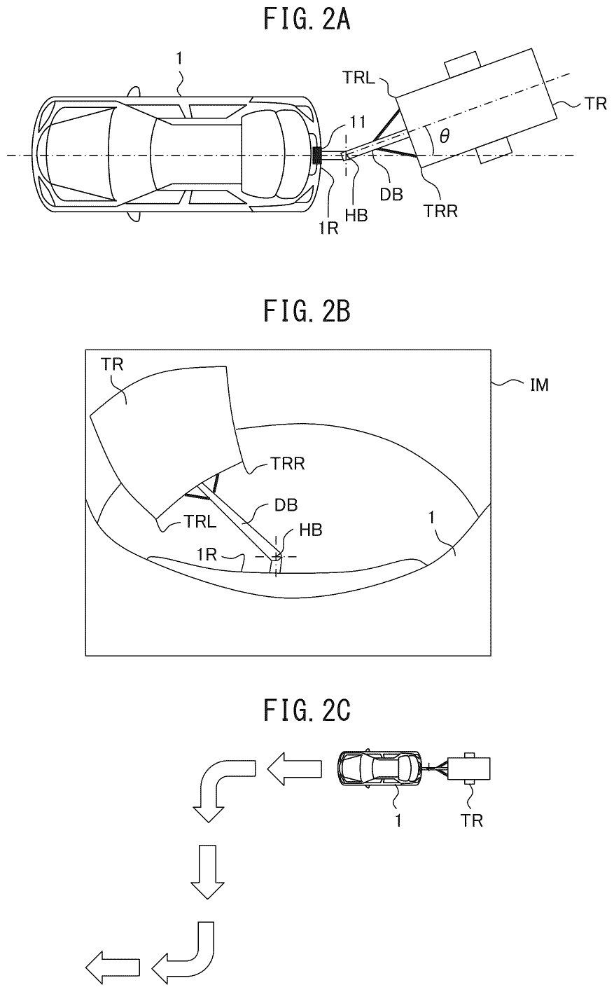

FIG. 1 is a view showing an example of a vehicle 1 to which a hitch angle calculation device 14 of a first embodiment is applied. FIG. 2A to FIG. 2C are views showing a relation between the vehicle 1 shown in FIG. 1, trailer TR and tow bar DB. Specifically, FIG. 2A is a view of the vehicle 1, the trailer TR, and the tow bar DB from above. FIG. 2B is a view showing an example of an image IM including the trailer TR and the tow bar DB shot by a camera 11 mounted on the vehicle 1. FIG. 2C is a view showing an example of a calibration travel of the vehicle 1. In the example shown in FIG. 1 to FIG. 2C, the vehicle 1 tows the trailer TR via the tow bar DB. The vehicle 1 includes camera 11, HMI (Human Machine Interface) 12, vehicle control device 13, steering actuator 13A, braking actuator 13B, drive actuator 13C, and hitch angle calculation device 14. The camera 11 is arranged, for example, at a rear end portion 1R of the vehicle 1. The camera 11 shoots the rear (right side of the FIG. 2A) of the vehicle 1 and transmits the image (e.g., fisheye lens image, etc.) IM (see FIG. 2B) including the trailer TR and the tow bar DB to the hitch angle calculation device 14. As shown in FIG. 2A and FIG. 2B, the tow bar DB is fixed to the trailer TR, is connected to the vehicle 1, and can rotate about a hitch ball HB.

The HMI 12 has a function of receiving various operations of a driver of the vehicle 1, and transmits signals indicating the operations of the driver of the vehicle 1 to the vehicle control device 13. The vehicle control device 13 controls the steering actuator 13A, the braking actuator 13B, and the drive actuator 13C based on the signals and the like transmitted from the HMI 12.

The hitch angle calculation device 14 is configured by a microcomputer including communication interface (I/F) 141, memory 142, and processor 143. The communication interface 141 has an interface circuit for connecting the hitch angle calculation device 14 to the camera 11, the HMI 12, and the vehicle control device 13. The memory 142 stores a program used in a process executed by the processor 143 and various data. The processor 143 has a function as an acquisition unit 3A, a function as a first calculation unit 3B, a function as a transformation unit 3C, a function as a second calculation unit 3D, a function as a removal unit 3E, a function as a third calculation unit 3F, and a function as a hitch angle calculation unit 3G. The acquisition unit 3A acquires the image IM including the trailer TR and the tow bar DB shot by the camera 11. In detail, the acquisition unit 3A acquires a plurality of images IM, . . . shot by the camera 11 at a plurality of time points during the calibration travel of the vehicle 1. The acquisition unit 3A acquires an image (hitch angle calculation target image) shot by the camera 11 at a predetermined time point after the calibration travel of the vehicle 1. The first calculation unit 3B calculates coordinates of left lower end TRL (see FIG. 2B) of the trailer TR, right lower end TRR (see FIG. 2B) of the trailer TR, and the hitch ball HB (see FIG. 2B) on the images. The left lower end TRL of the trailer TR, the right lower end TRR of the trailer TR, and the hitch ball HB are included in each of the plurality of images IM, . . . acquired by the acquisition unit 3A.

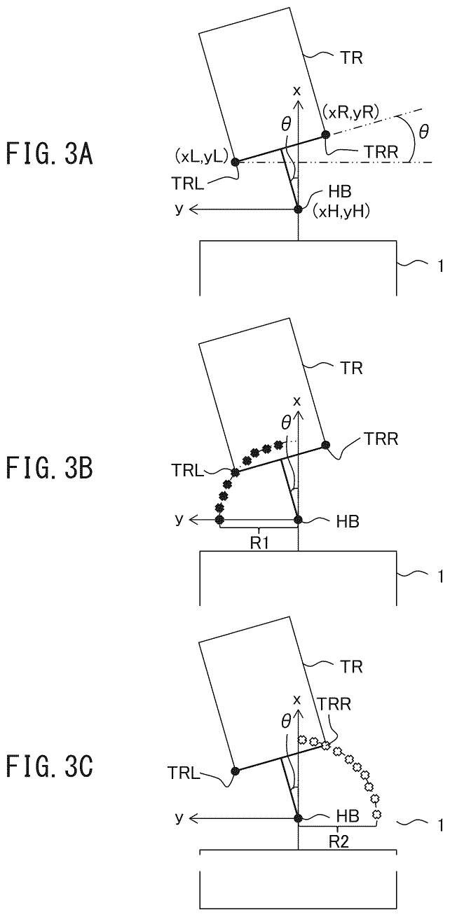

The transformation unit 3C transforms the coordinates of the left lower end TRL of the trailer TR on the images calculated by the first calculation unit 3B to the coordinates of the left lower end TRL of the trailer TR in a world coordinate system, for example, by using a known technique called a coordinate transformation or the like. The transformation unit 3C transforms the coordinates of the right lower end TRR of the trailer TR on the images calculated by the first calculation unit 3B to the coordinates of the right lower end TRR of the trailer TR in the world coordinate system. Furthermore, the transformation unit 3C transforms the coordinates of the hitch ball HB on the images calculated by the first calculation unit 3B to the coordinates of the hitch ball HB in the world coordinate system. Specifically, the transformation unit 3C transforms the coordinate of the left lower end TRL on the image IM shown in FIG. 2B to the coordinate (xL, yL) (see FIG. 3A) of the left lower end TRL in the world coordinate system, transforms the coordinate of the right lower end TRR on the image IM shown in FIG. 2B to the coordinate (xR, yR) (see FIG. 3A) of the right lower end TRR in the world coordinate system, and transforms the coordinate of the hitch ball HB on the image IM shown in FIG. 2B to the coordinate (xH, yH) (see FIG. 3A) of the hitch ball HB in the world coordinate system.

FIG. 3A to FIG. 3C are views showing an example of a transformation from the coordinates on the image IM shown in FIG. 2B to the coordinates in the world coordinate system and the like. Specifically, FIG. 3A shows an example of the transformation from the coordinates on the image IM shown in FIG. 2B to coordinates in the world coordinate system. FIG. 3B is a view showing an example of an average value (first average value) R1 of distance between the left lower end TRL of the trailer TR and the hitch ball HB in the world coordinate system during the calibration travel of the vehicle 1 calculated by the second calculation unit 3D. FIG. 3C is a view showing an example of the average value (second average value) R2 of the distance between the right lower end TRR of the trailer TR and the hitch ball HB in the world coordinate system during the calibration travel of the vehicle 1 calculated by the second calculation unit 3D. In the example shown in FIG. 3A to FIG. 3C, the x-axis of the world coordinate system is set so as to pass through the hitch ball HB and extend backward (rightward in FIG. 2A, upward in FIG. 3A to FIG. 3C) in the direction of travel of the vehicle 1. The y-axis of the world coordinate system is set so as to pass through the hitch ball HB and extend rightward (upward in FIG. 2A, leftward in FIG. 3A to FIG. 3C) of the vehicle 1.

In the example shown in FIG. 1 to FIG. 3C, the second calculation unit 3D calculates the average value (first average value) R1 (see FIG. 3B) of the distance between the left lower end TRL and the hitch ball HB in the world coordinate system during the calibration travel of the vehicle 1 based on the coordinates (xL, yL) (see FIG. 3A) of the left lower end TRL in the world coordinate system and the coordinates (xH, yH) (see FIG. 3A) of the hitch ball HB in the world coordinate system at the plurality of time points during the calibration travel of the vehicle 1. The second calculation unit 3D calculates the average value (second average value) R2 (see FIG. 3C) of the distance between the right lower end TRR and the hitch ball HB in the world coordinate system during the calibration travel of the vehicle 1 based on the coordinates (xR, yR) (see FIG. 3A) of the right lower end TRR in the world coordinate system and the coordinates (xH, yH) of the hitch ball HB in the world coordinate system at the plurality of time points during the calibration travel of the vehicle 1.

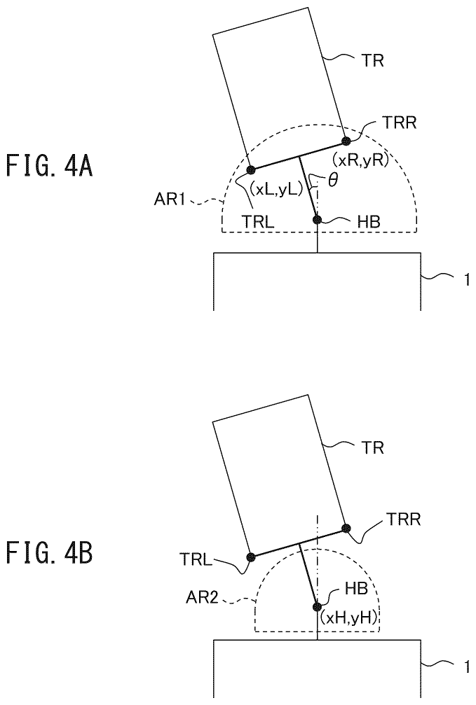

The plurality of images IM, . . . shot by the camera 11 at the plurality of time points during the calibration travel of the vehicle 1 may include an image shot by the camera 11 when condition for image recognition is bad (e.g., during bad weather, at night, when the vehicle 1 is traveling on a highway with a large gradient, etc.). In view of this point, in the example shown in FIG. 1 to FIG. 3C, the removal unit 3E removes the coordinates (xL, yL) of the left lower end TRL in the world coordinate system satisfying a first coordinate removal condition when the coordinates of the left lower end TRL of the trailer TR in the world coordinate system satisfying the first coordinate removal condition are included in the coordinates of the left lower end TRL of the trailer TR in the world coordinate system at the plurality of time points during the calibration travel of the vehicle 1. Specifically, when the coordinates (xL, yL) of the left lower end TRL in the world coordinate system during the calibration travel of the vehicle 1 are located outside of a predetermined first area AR1 (see FIG. 4A), the removal unit 3E determines that the first coordinate removal condition is satisfied, and removes the coordinates (xL, yL) of the left lower end TRL in the world coordinate system at time points when the coordinates (xL, yL) of the left lower end TRL of the trailer TR in the world coordinate system are located outside of the first area AR1. The removal unit 3E calculates a standard deviation (first standard deviation) of a difference between the distance between the left lower end TRL and the hitch ball HB in the world coordinate system during the calibration travel of the vehicle 1 and the first average value R1 (see FIG. 3B). Furthermore, when the difference between the distance between the left lower end TRL and the hitch ball HB in the world coordinate system during the calibration travel of the vehicle 1 and the first average value R1 is more than twice as large as the first standard deviation, the removal unit 3E determines that the first coordinate removal condition is satisfied and removes the coordinates (xL, yL) of the left lower end TRL in the world coordinate system at time points when the difference between the distance between the left lower end TRL and the hitch ball HB in the world coordinate system and the first average value R1 is more than twice as large as the first standard deviation.

The removal unit 3E removes the coordinates (xR, yR) of the right lower end TRR in the world coordinate system satisfying a second coordinate removal condition when the coordinates (xR, yR) of the right lower end TRR in the world coordinate system satisfying the second coordinate removal condition are included in the coordinates (xR, yR) of the right lower end TRR in the world coordinate system at the plurality of time points during the calibration travel of the vehicle 1. Specifically, when the coordinates (xR, yR) of the right lower end TRR in the world coordinate system during the calibration travel of the vehicle 1 are located outside the first area AR1 (see FIG. 4A), the removal unit 3E determines that the second coordinate removal condition is satisfied, and removes the coordinates (xR, yR) of the right lower end TRR in the world coordinate system at time points when the coordinates (xR, yR) of the right lower end TRR in the world coordinate system are located outside the first area AR1. The removal unit 3E calculates the standard deviation (second standard deviation) of the difference between the distance between the right lower end TRR and the hitch ball HB in the world coordinate system during the calibration travel of the vehicle 1 and the second average value R2 (see FIG. 3C). Furthermore, when the difference between the distance between the right lower end TRR and the hitch ball HB in the world coordinate system during the calibration travel of the vehicle 1 and the second average value R2 is more than twice as large as the second standard deviation, the removal unit 3E determines that the second coordinate removal condition is satisfied, and removes the coordinates (xR, yR) of the right lower end TRR in the world coordinate system at time points when the difference between the distance between the right lower end TRR and the hitch ball HB in the world coordinate system and the second average value R2 is more than twice as large as the second standard deviation.

Furthermore, the removal unit 3E removes the coordinates (xH, yH) of the hitch ball HB in the world coordinate system satisfying a third coordinate removal condition when the coordinates (xH, yH) of the hitch ball HB in the world coordinate system satisfying the third coordinate removal condition are included in the coordinates (xH, yH) of the hitch ball HB in the world coordinate system at the plurality of time points during the calibration travel of the vehicle 1. Specifically, when the coordinates (xH, yH) of the hitch ball HB in the world coordinate system during the calibration travel of the vehicle 1 are located outside a predetermined second area AR2 (see FIG. 4B), the removal unit 3E determines that the third coordinate removal condition is satisfied, and removes the coordinates (xH, yH) of the hitch ball HB in the world coordinate system at time points when the coordinates (xH, yH) of the hitch ball HB in the world coordinate system are located outside of the second area AR2.

FIG. 4A and FIG. 4B are views showing example of the relationship between the first area AR1, the coordinate (xL, yL) of the left lower end TRL in the world coordinate system at a time point during the calibration travel of the vehicle 1, and the coordinate (xR, yR) of the right lower end TRR in the world coordinate system at that time point and the like. Specifically, FIG. 4A shows the example of the relationship between the first area AR1, the coordinate (xL, yL) of the left lower end TRL in the world coordinate system at a time point during the calibration travel of the vehicle 1, and the coordinate (xR, yR) of the right lower end TRR in the world coordinate system at that time point, and FIG. 4B shows an example of the relationship between the second area AR2 and the coordinate (xH, yH) of the hitch ball HB in the world coordinate system at a time point during the calibration travel of the vehicle 1.

In the example shown in FIG. 1 to FIG. 4B, the third calculation unit 3F calculates an average value of the distance between the left lower end TRL and the hitch ball HB in the world coordinate system (third average value) or an average value of the distance between the right lower end TRR and the hitch ball HB in the world coordinate system (fourth average value) by using the coordinates (xL, yL) of the left lower end TRL in the world coordinate system, the coordinates (xR, yR) of the right lower end TRR in the world coordinate system, and the coordinates (xH, yH) of the hitch ball HB in the world coordinate system at the plurality of time points during the calibration travel of the vehicle 1 which are not removed by the removal unit 3E. The third calculation unit 3F calculates the average value of the coordinates (xH, yH) of the hitch ball HB in the world coordinate system by using the coordinates (xH, yH) of the hitch ball HB in the world coordinate system at the plurality of time points during the calibration travel of the vehicle 1 which are not removed by the removal unit 3E.

The hitch angle calculation unit 3G calculates the hitch angle θ (see FIG. 2A, FIG. 3A, etc.) of the trailer TR at the predetermined time point based on an image (hitch angle calculation target image) shot by the camera 11 at the predetermined time point after the calibration travel of the vehicle 1. As shown in FIG. 3A, the hitch angle θ of the trailer TR at the predetermined time point is equal to the angle θ formed by the straight line connecting the coordinate (xL, yL) of the left lower end TRL and the coordinate (xR, yR) of the right lower end TRR in the world coordinate system at that predetermined time point, and the y-axis in the world coordinate system.

Specifically, in the example shown in FIG. 1 to FIG. 4B, the hitch angle calculation unit 3G calculates the coordinates of the left lower end TRL, the right lower end TRR, and the hitch ball HB on the image included in the hitch angle calculation target image shot at the predetermined time point after the calibration travel of the vehicle 1. The hitch angle calculation unit 3G transforms the coordinates of the left lower end TRL, the right lower end TRR, and the hitch ball HB on the image included in the hitch angle calculation target image to the coordinates in the world coordinate system. Furthermore, the hitch angle calculation unit 3G calculates the distance in the world coordinate system between the left lower end TRL and hitch ball HB included in the hitch angle calculation target image and the distance in the world coordinate system between the right lower end TRR and the hitch ball HB included in the hitch angle calculation target image, based on the coordinate (xL, yL) of the left lower end TRL in the world coordinate system included in the hitch angle calculation target image, the coordinate (xR, yR) of the right lower end TRR in the world coordinate system included in the hitch angle calculation target image, and the coordinate (xH, yH) of the hitch ball HB in the world coordinate system included in the hitch angle calculation target image.

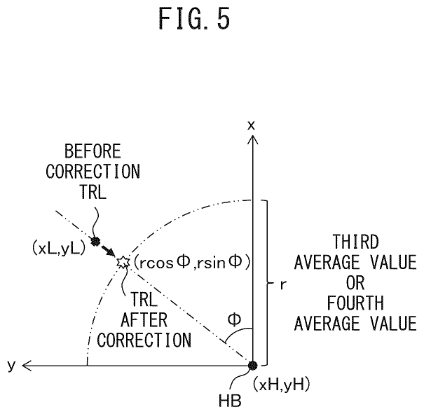

The hitch angle calculation unit 3G corrects the coordinate (xL, yL) in the world coordinate system of the left lower end TRL included in the hitch angle calculation target image so that the distance between the left lower end TRL and the hitch ball HB in the world coordinate system included in the hitch angle calculation target image is equal to the third average value or the fourth average value r (see FIG. 5) calculated by the third calculation unit 3F. Specifically, the hitch angle calculation unit 3G corrects the coordinate in the world coordinate system of the left lower end TRL included in the hitch angle calculation target image so that the distance between the left lower end TRL and the hitch ball HB in the world coordinate system included in the hitch angle calculation target image is equal to the third average value or the fourth average value r calculated by the third calculation unit 3F and so that the orientation of the left lower end TRL with respect to the hitch ball HB in the world coordinate system does not change.

FIG. 5 is a view for explaining an example of correction of the coordinate (xL, yL) of the left lower end TRL in the world coordinate system included in the hitch angle calculation target image performed by the hitch angle calculation unit 3G. In the example shown in FIG. 1 to FIG. 5, as shown in FIG. 5, the coordinate (xL, yL) of the left lower end TRL in the world coordinate system included in the hitch angle calculation target image is corrected by the hitch angle calculation unit 3G to the corrected coordinate (r cos Φ, r sin Φ) of the left lower end TRL in the world coordinate system. Specifically, in the example shown in FIG. 5, the straight line connecting the left lower end TRL before correction and the hitch ball HB in the world coordinate system forms an angle Φ with the x-axis. The distance ((xL−XH)²+(yL−yH)²)^{1/2} between the left lower end TRL before correction and the hitch ball HB in the world coordinate system is greater than the third average value or the fourth average value r. Thus, as indicated by the arrow in FIG. 5, the hitch angle calculation unit 3G corrects the coordinate of the left lower end TRL in the world coordinate system from (xL, yL) to (r cos Φ, r sin Φ) so that the angle Φ is formed between the x-axis and the straight line connecting the left lower end TRL after correction and hitch ball HB in the world coordinate system, and so that the distance between the left lower end TRL after correction and hitch ball HB in the world coordinate system is equal to the third average value or the fourth average value r.

In the example shown in FIG. 1 to FIG. 5, the hitch angle calculation unit 3G corrects the coordinate (xR, yR) of the right lower end TRR in the world coordinate system included in the hitch angle calculation target image so that the distance between the right lower end TRR and the hitch ball HB in the world coordinate system included in the hitch angle calculation target image is equal to the third average value or the fourth average value r (see FIG. 5) calculated by the third calculation unit 3F. Specifically, the hitch angle calculation unit 3G corrects the coordinate of the right lower end TRR in the world coordinate system included in the hitch angle calculation target image so that the distance between the right lower end TRR and the hitch ball HB in the world coordinate system included in the hitch angle calculation target image is equal to the third average value or the fourth average value r calculated by the third calculation unit 3F, and so that the orientation of the right lower end TRR with respect to the hitch ball HB in the world coordinate system does not change.

Furthermore, the hitch angle calculation unit 3G calculates the hitch angle θ of the trailer TR at the predetermined time point based on the corrected coordinate in the world coordinate system of the left lower end TRL included in the hitch angle calculation target image and the corrected coordinate in the world coordinate system of the right lower end TRR included in the hitch angle calculation target image (more specifically, by a calculation method of the hitch angle θ shown in FIG. 3A).

As described above, in the example shown in FIG. 1 to FIG. 5, when the distance between the coordinates of the left lower end TRL and the right lower end TRR in the world coordinate system, which are configured so as to be movable along an arc with radius r (third average value or fourth average value r) from the hitch ball HB, and the coordinate of the hitch ball HB in the world coordinate system is not equal to the third average value or fourth average value r, the hitch angle calculation unit 3G corrects the coordinates of the left lower end TRL and the right lower end TRR in the world coordinate system so that the distance between the coordinates of the left lower end TRL and right lower end TRR in the world coordinate system and the coordinate of the hitch ball HB in the world coordinate system is equal to the third average value or fourth average value r. Thus, in the example shown in FIG. 1 to FIG. 5, the hitch angle calculation unit 3G can appropriately calculate the hitch angle θ of the trailer TR based on the corrected coordinates of the left lower end TRL and the right lower end TRR in the world coordinate system.

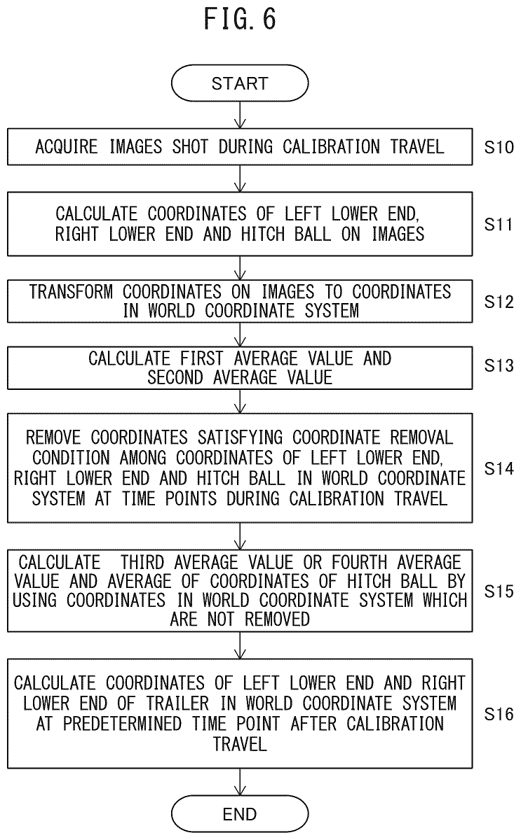

FIG. 6 is a flowchart for explaining an example of the process executed by the processor 143 of the hitch angle calculation device 14 of the first embodiment.

In the example shown in FIG. 6, at step S10, the acquisition unit 3A acquires the plurality of images IM, . . . shot by the camera 11 at the plurality of time points during the calibration travel of the vehicle 1.

At step S11, the first calculation unit 3B calculates the coordinates of the left lower end TRL, the right lower end TRR, and the hitch ball HB on the images IM, . . . included in each of the plurality of images IM, . . . acquired at step S10.

At step S12, the transformation unit 3C transforms the coordinates of the left lower end TRL, the right lower end TRR and the hitch ball HB on the images IM, . . . calculated at step S11 to coordinates in the world coordinate system.

At step S13, the second calculation unit 3D calculates the average value (first average value) R1 of the distance between the left lower end TRL and the hitch ball HB in the world coordinate system and the average value (second average value) R2 of the distance between the right lower end TRR and the hitch ball HB in the world coordinate system during the calibration travel of the vehicle 1 based on the coordinates in the world coordinate system transformed at step S12.

At step S14, the removal unit 3E removes the coordinates satisfying the coordinate removal conditions (first coordinate removal condition, second coordinate removal condition or third coordinate removal condition) among the coordinates of the left lower end TRL, the right lower end TRR, and the hitch ball HB in the world coordinate system at the plurality of time points during the calibration travel of the vehicle 1.

Specifically, in the example shown in FIG. 6, after step S14, the processor 143 determines whether the learning using the plurality of images IM, . . . shot during the calibration travel of the vehicle 1 is successful based on the number of the coordinates of the left lower end TRL in the world coordinate system during the calibration travel of the vehicle 1 which are not removed at step S14, the number of the coordinates of the right lower end TRR in the world coordinate system during the calibration travel of the vehicle 1 which are not removed at step S14, the number of the coordinates of the hitch ball HB in the world coordinate system during the calibration travel of the vehicle 1 which are not removed at step S14, and the first standard deviation and the second standard deviation calculated by the removal unit 3E. When the learning is successful, it proceeds to step S15, and when the learning is not successful, it returns to step S10.

At step S15, the third calculation unit 3F calculates the third average value or the fourth average value r and the average value of the coordinates (xH, yH) of the hitch ball HB in the world coordinate system by using the coordinates of the left lower end TRL, the right lower end TRR, and the hitch ball HB in the world coordinate system at the plurality of time points during the calibration travel of the vehicle 1 which are not removed at step S14.

At step S16, the hitch angle calculation unit 3G corrects the coordinates in the world coordinate system of the left lower end TRL and right lower end TRR included in the image (hitch angle calculation target image) shot by the camera 11 at the predetermined time point after the calibration travel of the vehicle 1, and calculates the hitch angle θ of the trailer TR based on the corrected coordinates of the left lower end TRL and right lower end TRR in the world coordinate system.

The transformation unit 3C may perform the transformation from the coordinates on the images IM, . . . to the coordinates in the world coordinate system by using a technique (for example, technique specific to the manufacturer of the vehicle 1 or the like) other than the known technique.

As described above, although the embodiments of the hitch angle calculation device, the hitch angle calculation method, and the non-transitory recording medium of the present disclosure have been described with reference to the drawings, the hitch angle calculation device, the hitch angle calculation method, and the non-transitory recording medium of the present disclosure are not limited to the embodiments described above, and may be appropriately changed without departing from the scope of the present disclosure. The configuration of each example of the embodiments described above may be appropriately combined. In each example of the above-described embodiments, the process performed in the hitch angle calculation device 14 has been described as a software process performed by executing the program, but the process performed in the hitch angle calculation device 14 may be a process performed by hardware. Alternatively, the process performed by the hitch angle calculation device 14 may a combination of both software and hardware. Further, the program (program for realizing the function of the processor 143 of the hitch angle calculation device 14) stored in the memory 142 of the hitch angle calculation device 14 may be recorded in a computer-readable storage medium (non-transitory recording medium) such as semiconductor memory, magnetic recording medium, optical recording medium, or the like for providing, distribution or the like.

1. A hitch angle calculation device comprising a processor configured to:
acquire images shot by a camera mounted on a vehicle towing a trailer via a tow bar at a plurality of time points during a calibration travel of the vehicle;
calculate coordinates of left lower end of the trailer, right lower end of the trailer, and hitch ball on the images, the left lower end of the trailer, the right lower end of the trailer, and the hitch ball being included in each of the images;
transform the coordinates of the left lower end on the images to the coordinates of the left lower end in a world coordinate system, transform the coordinates of the right lower end on the images to the coordinates of the right lower end in the world coordinate system, and transform the coordinates of the hitch ball on the images to the coordinates of the hitch ball in the world coordinate system;
calculate a first average value which is an average value of a distance between the left lower end and the hitch ball in the world coordinate system during the calibration travel of the vehicle based on the coordinates of the left lower end and the hitch ball in the world coordinate system at time points during the calibration travel of the vehicle, and calculate a second average value which is the average value of the distance between the right lower end and the hitch ball in the world coordinate system during the calibration travel of the vehicle based on the coordinates of the right lower end and the hitch ball in the world coordinate system at time points during the calibration travel of the vehicle;
remove the coordinates of the left lower end in the world coordinate system satisfying a first coordinate removal condition when the coordinates of the left lower end in the world coordinate system satisfying the first coordinate removal condition are included in the coordinates of the left lower end in the world coordinate system at time points during the calibration travel of the vehicle, remove the coordinates of the right lower end in the world coordinate system satisfying a second coordinate removal condition when the coordinates of the right lower end in the world coordinate system satisfying the second coordinate removal condition are included in the coordinates of the right lower end in the world coordinate system at time points during the calibration travel of the vehicle, and remove the coordinates of the hitch ball in the world coordinate system satisfying a third coordinate removal condition when the coordinates of the hitch ball in the world coordinate system satisfying the third coordinate removal condition are included in the coordinates of the hitch ball in the world coordinate system at time points during the calibration travel of the vehicle;
calculate third average value or fourth average value and average value of the coordinates of the hitch ball in the world coordinate system by using the coordinates of the left lower end, the right lower end, and the hitch ball in the world coordinate system at the plurality of time points during the calibration travel of the vehicle which are not removed, the third average value being an average value of a distance between the left lower end and the hitch ball in the world coordinate system, the fourth average value being an average value of a distance between the right lower end and the hitch ball in the world coordinate system; and
calculate a hitch angle of the trailer at a predetermined time point based on a hitch angle calculation target image, which is an image shot by the camera at the predetermined time point after the calibration travel of the vehicle, wherein
the processor is configured to:
calculate coordinates of the left lower end, the right lower end, and the hitch ball on the image included in the hitch angle calculation target image;
transform the coordinates of the left lower end, the right lower end, and the hitch ball on the image included in the hitch angle calculation target image to coordinates in the world coordinate system;
calculate distance in the world coordinate system between the left lower end and the hitch ball included in the hitch angle calculation image and distance in the world coordinate system between the right lower end and the hitch ball included in the hitch angle calculation target image based on the coordinates in the world coordinate system of the left lower end, the right lower end, and the hitch ball included in the hitch angle calculation target image;
correct the coordinate in the world coordinate system of the left lower end included in the hitch angle calculation target image so that the distance in the world coordinate system between the left lower end and the hitch ball included in the hitch angle calculation target image is equal to the third average value or the fourth average value;
correct the coordinate in the world coordinate system of the right lower end included in the hitch angle calculation target image so that the distance in the world coordinate system between the right lower end and the hitch ball included in the hitch angle calculation target image is equal to the third average value or the fourth average value; and
calculate the hitch angle of the trailer at the predetermined time point based on the corrected coordinate in the world coordinate system of the left lower end included in the hitch angle calculation target image and the corrected coordinate in the world coordinate system of the right lower end included in the hitch angle calculation target image.

2. The hitch angle calculation device according to claim 1, wherein the processor is configured to:
correct the coordinate in the world coordinate system of the left lower end included in the hitch angle calculation target image so that the distance in the world coordinate system between the left lower end and the hitch ball included in the hitch angle calculation target image is equal to the third average value or the fourth average value and so that an orientation of the left lower end with respect to the hitch ball in the world coordinate system does not change; and
correct the coordinate in the world coordinate system of the right lower end included in the hitch angle calculation target image so that the distance in the world coordinate system between the right lower end and the hitch ball included in the hitch angle calculation target image is equal to the third average value or the fourth average value and so that an orientation of the right lower end with respect to the hitch ball in the world coordinate system does not change.

3. The hitch angle calculation device according to claim 1, wherein the processor is configured to:
determine that the first coordinate removal condition is satisfied when the coordinates of the left lower end in the world coordinate system during the calibration travel of the vehicle are located outside of a predetermined first area, and remove the coordinates of the left lower end in the world coordinate system at time points when the coordinates of the left lower end in the world coordinate system are located outside of the first area;
determine that the second coordinate removal condition is satisfied when the coordinates of the right lower end in the world coordinate system during the calibration travel of the vehicle are located outside of the first area, and remove the coordinates of the right lower end in the world coordinate system at time points when the coordinates of the right lower end in the world coordinate system are located outside of the first area; and
determine that the third coordinate removal condition is satisfied when the coordinates of the hitch ball in the world coordinate system during the calibration travel of the vehicle are located outside of a predetermined second area, and remove the coordinates of the hitch ball in the world coordinate system at time points when the coordinates of the hitch ball in the world coordinate system are located outside of the second area.

4. A hitch angle calculation method comprising:
acquiring images shot by a camera mounted on a vehicle towing a trailer via a tow bar at a plurality of time points during a calibration travel of the vehicle;
calculating coordinates of left lower end of the trailer, right lower end of the trailer, and hitch ball on the images, the left lower end of the trailer, the right lower end of the trailer, and the hitch ball being included in each of the images;
transforming the coordinates of the left lower end on the images to the coordinates of the left lower end in a world coordinate system, transforming the coordinates of the right lower end on the images to the coordinates of the right lower end in the world coordinate system, and transforming the coordinates of the hitch ball on the images to the coordinates of the hitch ball in the world coordinate system;
calculating a first average value which is an average value of a distance between the left lower end and the hitch ball in the world coordinate system during the calibration travel of the vehicle based on the coordinates of the left lower end and the hitch ball in the world coordinate system at time points during the calibration travel of the vehicle, and calculating a second average value which is the average value of the distance between the right lower end and the hitch ball in the world coordinate system during the calibration travel of the vehicle based on the coordinates of the right lower end and the hitch ball in the world coordinate system at time points during the calibration travel of the vehicle;
removing the coordinates of the left lower end in the world coordinate system satisfying a first coordinate removal condition when the coordinates of the left lower end in the world coordinate system satisfying the first coordinate removal condition are included in the coordinates of the left lower end in the world coordinate system at time points during the calibration travel of the vehicle, removing the coordinates of the right lower end in the world coordinate system satisfying a second coordinate removal condition when the coordinates of the right lower end in the world coordinate system satisfying the second coordinate removal condition are included in the coordinates of the right lower end in the world coordinate system at time points during the calibration travel of the vehicle, and removing the coordinates of the hitch ball in the world coordinate system satisfying a third coordinate removal condition when the coordinates of the hitch ball in the world coordinate system satisfying the third coordinate removal condition are included in the coordinates of the hitch ball in the world coordinate system at time points during the calibration travel of the vehicle;
calculating third average value or fourth average value and average value of the coordinates of the hitch ball in the world coordinate system by using the coordinates of the left lower end, the right lower end, and the hitch ball in the world coordinate system at the plurality of time points during the calibration travel of the vehicle which are not removed, the third average value being an average value of a distance between the left lower end and the hitch ball in the world coordinate system, the fourth average value being an average value of a distance between the right lower end and the hitch ball in the world coordinate system; and
calculating a hitch angle of the trailer at a predetermined time point based on a hitch angle calculation target image, which is an image shot by the camera at the predetermined time point after the calibration travel of the vehicle, wherein
coordinates of the left lower end, the right lower end, and the hitch ball on the image included in the hitch angle calculation target image are calculated,
the coordinates of the left lower end, the right lower end, and the hitch ball on the image included in the hitch angle calculation target image are transformed to coordinates in the world coordinate system,
distance in the world coordinate system between the left lower end and the hitch ball included in the hitch angle calculation image and distance in the world coordinate system between the right lower end and the hitch ball included in the hitch angle calculation target image are calculated based on the coordinates in the world coordinate system of the left lower end, the right lower end, and the hitch ball included in the hitch angle calculation target image,
the coordinate in the world coordinate system of the left lower end included in the hitch angle calculation target image is corrected so that the distance in the world coordinate system between the left lower end and the hitch ball included in the hitch angle calculation target image is equal to the third average value or the fourth average value,
the coordinate in the world coordinate system of the right lower end included in the hitch angle calculation target image is corrected so that the distance in the world coordinate system between the right lower end and the hitch ball included in the hitch angle calculation target image is equal to the third average value or the fourth average value, and
the hitch angle of the trailer at the predetermined time point is calculated based on the corrected coordinate in the world coordinate system of the left lower end included in the hitch angle calculation target image and the corrected coordinate in the world coordinate system of the right lower end included in the hitch angle calculation target image.

5. A non-transitory recording medium having recorded thereon a computer program for causing a processor to perform a process comprising:
acquiring images shot by a camera mounted on a vehicle towing a trailer via a tow bar at a plurality of time points during a calibration travel of the vehicle;
calculating coordinates of left lower end of the trailer, right lower end of the trailer, and hitch ball on the images, the left lower end of the trailer, the right lower end of the trailer, and the hitch ball being included in each of the images;
transforming the coordinates of the left lower end on the images to the coordinates of the left lower end in a world coordinate system, transforming the coordinates of the right lower end on the images to the coordinates of the right lower end in the world coordinate system, and transforming the coordinates of the hitch ball on the images to the coordinates of the hitch ball in the world coordinate system;
calculating a first average value which is an average value of a distance between the left lower end and the hitch ball in the world coordinate system during the calibration travel of the vehicle based on the coordinates of the left lower end and the hitch ball in the world coordinate system at time points during the calibration travel of the vehicle, and calculating a second average value which is the average value of the distance between the right lower end and the hitch ball in the world coordinate system during the calibration travel of the vehicle based on the coordinates of the right lower end and the hitch ball in the world coordinate system at time points during the calibration travel of the vehicle;
removing the coordinates of the left lower end in the world coordinate system satisfying a first coordinate removal condition when the coordinates of the left lower end in the world coordinate system satisfying the first coordinate removal condition are included in the coordinates of the left lower end in the world coordinate system at time points during the calibration travel of the vehicle, removing the coordinates of the right lower end in the world coordinate system satisfying a second coordinate removal condition when the coordinates of the right lower end in the world coordinate system satisfying the second coordinate removal condition are included in the coordinates of the right lower end in the world coordinate system at time points during the calibration travel of the vehicle, and removing the coordinates of the hitch ball in the world coordinate system satisfying a third coordinate removal condition when the coordinates of the hitch ball in the world coordinate system satisfying the third coordinate removal condition are included in the coordinates of the hitch ball in the world coordinate system at time points during the calibration travel of the vehicle;
calculating third average value or fourth average value and average value of the coordinates of the hitch ball in the world coordinate system by using the coordinates of the left lower end, the right lower end, and the hitch ball in the world coordinate system at the plurality of time points during the calibration travel of the vehicle which are not removed, the third average value being an average value of a distance between the left lower end and the hitch ball in the world coordinate system, the fourth average value being an average value of a distance between the right lower end and the hitch ball in the world coordinate system; and
calculating a hitch angle of the trailer at a predetermined time point based on a hitch angle calculation target image, which is an image shot by the camera at the predetermined time point after the calibration travel of the vehicle, wherein
coordinates of the left lower end, the right lower end, and the hitch ball on the image included in the hitch angle calculation target image are calculated,
the coordinates of the left lower end, the right lower end, and the hitch ball on the image included in the hitch angle calculation target image are transformed to coordinates in the world coordinate system,
distance in the world coordinate system between the left lower end and the hitch ball included in the hitch angle calculation image and distance in the world coordinate system between the right lower end and the hitch ball included in the hitch angle calculation target image are calculated based on the coordinates in the world coordinate system of the left lower end, the right lower end, and the hitch ball included in the hitch angle calculation target image,
the coordinate in the world coordinate system of the left lower end included in the hitch angle calculation target image is corrected so that the distance in the world coordinate system between the left lower end and the hitch ball included in the hitch angle calculation target image is equal to the third average value or the fourth average value,
the coordinate in the world coordinate system of the right lower end included in the hitch angle calculation target image is corrected so that the distance in the world coordinate system between the right lower end and the hitch ball included in the hitch angle calculation target image is equal to the third average value or the fourth average value, and
the hitch angle of the trailer at the predetermined time point is calculated based on the corrected coordinate in the world coordinate system of the left lower end included in the hitch angle calculation target image and the corrected coordinate in the world coordinate system of the right lower end included in the hitch angle calculation target image.
